(19) United States
(12) Patent Application Publication
(10) Pub. No.: US 2008/0223289 A1
(43) Pub. Date: Sep. 18, 2008

(54) PAPIER-MACHE APPARATUS AND METHODOLOGY FOR USING SAME

(75) Inventor: Jon E. Perkins, Reno, NV (US)

Correspondence Address: LONG & CHYBIK, 1575 DELUCCHI LANE, SUITE 32, RENO, NV, 89502, US

(73) Assignee: JILL E. CREATIONS, LLC, Ladera Ranch, CA (US)

(21) Appl. No.: 12/032,487

(22) Filed: Feb. 15, 2008

Related U.S. Application Data
(60) Provisional application No. 60/906,277, filed on Mar. 12, 2007.

(51) Int. Cl. B05C 11/02

(52) U.S. Cl. 118/40; 118/117

(57) ABSTRACT

One possible embodiment of the invention may be an apparatus and process for making papier-mâché. One possible version of the apparatus may comprise an open top container forming a hollow interior capable of holding an amount of papier-mâché solution; a papier-mâché media dispenser, a portion of which can reversibly sit within the hollow interior of the open top container, the dispenser further comprising a pair of dispenser walls spaced apart in parallel opposing configuration by a plurality of pins that are located between the dispenser walls; a papier-mâché media holder, the holder reversibly located between the dispenser walls, wherein a strip could be pulled from media held by the holder and could be generally interwoven through the pins to generally present a portion of the strip to the solution present in interior of the container.

### CROSS-REFERENCES TO RELATED APPLICATIONS

This application claims the benefit under 35 U.S.C. §119(e) of U.S. Provisional Patent Application No. 60/906277, filed on Mar. 12, 2007, contents of which are relied upon and incorporated by reference.

### STATEMENT REGARDING FEDERALLY SPONSORED

### RESEARCH OR DEVELOPMENT

Not Applicable

### REFERENCE TO A “MICROFICHE APPENDIX”

Not Applicable.

1. Field of the Invention

The present invention relates to devices for creating and dispensing papier-mâché.

2. Background

One of the more enjoyable craft activities is the creation and use of papier-mâché to make toys, artwork, and other such articles. Papier-mâché, coined from the French for ‘chewed up paper’ because of its appearance, could be described in one instance as a light and strong molding material that is generally formed by taking strips of media (e.g., waste paper, old news print, linen, cloth, other textiles or the like) and submerging them in an aqueous solution in a bowl, the solution substantially being made from a solvent (such as water); a sticking or adhesive agent (such as flour, liquid starch, or the like); and other possible additives (e.g., salt to prevent mold). During the submergence, the media generally becomes thoroughly wetted with the papier-mâché solution before being removed from the solution. As the properly wetted strips of media are then removed (generally one at a time) from the solution, the operator generally uses his (or her) fingers (e.g., pulling the wetted media strip between two fingers lightly pressed together) to strip off excess papier-mâché solution from the wetted slips of paper. The wetted strips of papier-mâché can then be applied to themselves, a mold, or the like to form a desired structure or parts that can later be formed into a desired structure.

Generally, the operation of this process, even by adults, can be a bit messy requiring aprons, protective covers for furniture, and other suitable protection measures to generally contain the mess of the papier-mâché formation and application as well as to generally ease cleanup. Even with the adoption of such protective measures, the use of adhesive agents, the use of water, the action of stripping off excess papier-mâché solution, and other inherent activities of papier-mâché manufacture as well as the overall “messy” and wet nature of papier-mâché itself, may still spread the “mess” contamination beyond the protected areas of the papier-mâché activity area.

In the case of younger practitioners of the art, the “mess” contamination may spread by an exponential factor to the surrounding environs and to that of the young artists themselves to such an extent that may leave the artists' parental relations and others wishing they did not have to use such a great amount of effort to clean the environs, and sometimes the young artists themselves, from the resulting aftermath of such an activity.

Additionally, outside of the concerns for mess containment, some older persons may generally lack a level of manual dexterity that could interfere with their ability to make the papier-mâché strip and thus substantially discouraging them from becoming practitioners and enjoying this activity.

What may be needed therefore is an apparatus and methodology that is substantially time effective, inexpensive, and easy to form papier-mâché from a continous strip of papier-mâché media. There is also the generally need to help contain the spreading of the mess that can often be associated with papier-mâché formation and application.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to allow papier-mâché practitioners to make papier-mâché strips with greater ease, less time, and less mess;

provide a papier-mâché forming apparatus that is generally self-contained;

the ability to make papier-mâché on demand from a continous strip of media;

the ability to easily make strips of papier-mâché of desired lengths; and

the ability to strip off excess papier-mâché solution from the papier-mâché strips.

These and other advantages may be realized by reference to the remaining portions of the specification, claims, and abstract.

Brief Description of One Embodiment of the Present Invention

One possible embodiment for an apparatus for making papier-mâché comprising an open top container forming a hollow interior capable of holding an amount of papier-mâché solution; a papier-mâché media dispenser, a portion of which can reversibly sit within the hollow interior of the open top container, the dispenser further comprising a pair of dispenser walls spaced apart in parallel opposing configuration by a plurality of pins that are located between the walls; a papier-mâché media holder, reversibly located between the dispenser walls; wherein the plurality of pins are so spaced as to allow a strip of the papier-mâché media being held by the papier-mâché media holder to be freely interwoven through several of the pins so as to movably present a portion of the strip media to papier-mâché solution present in the open top container.

Another version of this embodiment could be a papier-mâché apparatus comprising an open top container having a bottom and plurality of walls forming an exterior, the exterior denoting a hollow interior that can hold an amount of papier-mâché solution, at least one wall being a first wall and the wall opposing the first wall being a second wall; a papier-mâché media holder for supporting a papier-mâché media, the holder located on the exterior of the first wall; a cutting device located on the exterior of the second wall; at least one bottom roller located in the interior proximate the bottom and the first wall; one wiper device located in the interior proximate to the second wall; wherein a strip of papier-mâché media is taken from papier-mâché media supported by the papier-mâché media holder is threaded under at least one bottom roller to place the media in the amount of papier-mâché solution, the media then being taken from the bottom roller to be threaded through a wiper device, the media then being taken from the wiper device to be placed proximate the exterior by the cutting device.

Another version of this embodiment could be a papier-mâché making apparatus comprising an open top container with an exterior defining a hollow interior, the hollow interior containing a papier-mâché media holder, at least one bottom roller located proximate to the bottom of the container, and a wiper device, the interior further capable of receiving and holding an amount of papier-mâché solution; a hinged cover to allow access to the interior; a slot continuously connecting the interior to the exterior; wherein a portion of papier-mâché media loaded onto the papier-mâché media holder is stripped off and movably fed around at least a portion of at least one bottom roller to be in contact with the wiper device, the media being further brought from the wiper device to be fed into and then out of the slot.

The above-description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is substantially a cutaway perspective view of one embodiment of present invention.

FIG. 2 is substantially a cutaway perspective view of another embodiment of present invention.

FIG. 3 is substantially a cutaway perspective view of yet another embodiment of the present invention.

FIG. 3A is substantially a cutaway perspective view of a further embodiment of the present invention.

FIG. 4 is substantially is substantially a cutaway perspective view of yet a further embodiment of the present invention.

FIG. 5 is substantially a flowchart for one possible method of operating the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention 10, in at least one embodiment, could be a papier-mâché making apparatus 20 along with a method 100 for operating the papier-mâché making appartus 20.

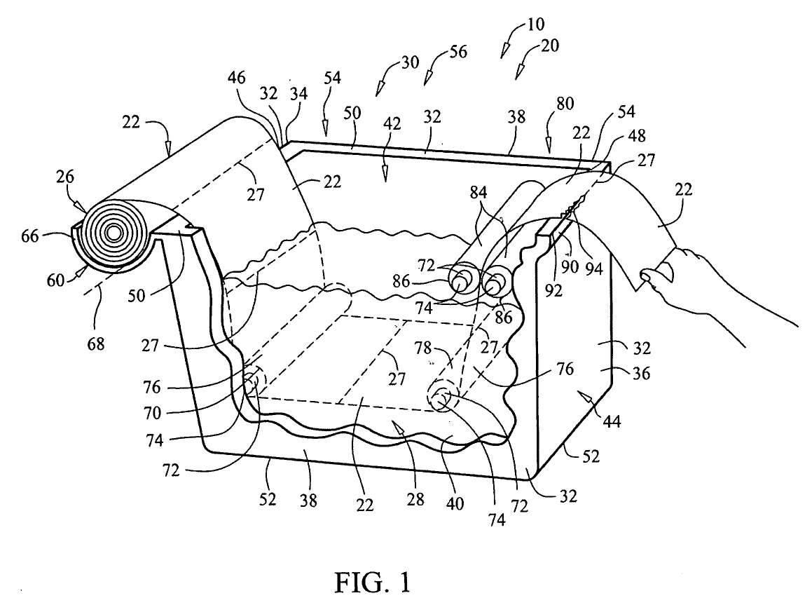

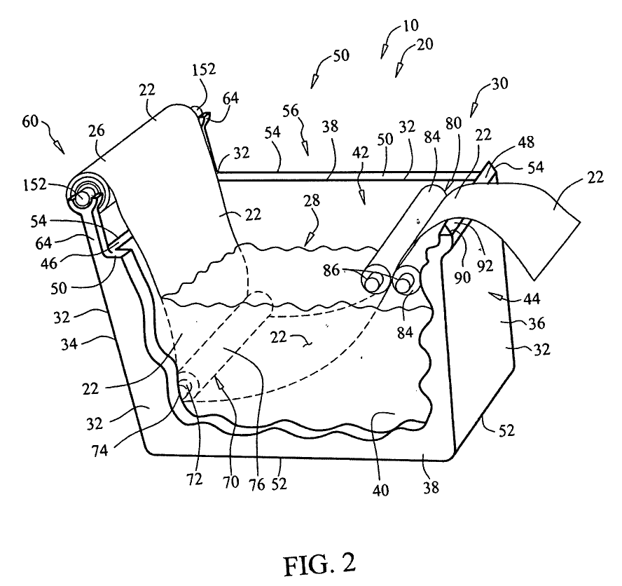

As substantially shown in FIGS. 1, 2, 3, and 3A, the papier-mâché making apparatus 20 could comprise an open top container 30 that generally supports a media holder 60, one or more bottom rollers 70, a wiper device 80, and cutting device 90. The open top container 30 could be made of a wide variety of materials known in the art, including transparent ones to allow the operator to more easily view the operations of the invention 10.

The open top container 30 could be so constructed as to be generally defined by four walls 32 and a bottom 40. One wall 32 could be a first end wall while the wall 32 opposing it could be a second end wall 36. A top edge 54 of a first end wall 34 could be a first edge 46 while a top edge 54 of an opposing second end wall 36 could be a second edge 48. The remaining two walls 32 could be opposing side walls 38. The four walls 32 could be continuously connected by their side edges 50 to one another to generally form a continous wall structure. Additionally, the four walls 32 may further have their lower edges 52 continuously connected to the bottom 40 to generally define a hollow interior 42 that is capable of holding a defined quantity of papier-mâché solution 28 (e.g., the papier-mâché solution could be made up utilizing one of the many formulas known to the art). The top edges 54 of the walls 32 could generally define the open top 56, which could generally connect a hollow interior 42 to an exterior 44 of the open top container 30.

In one embodiment, the papier-mâché media 22 could be a continous papier-mâché media roll 28, a papier-mâché media stack 29 (e.g., a definite, continuous length of papier-mâché media 22 folded in accordion fashion), and the like. At least one version of papier-mâché media 22 could have sets of perforations 28 laterally disposed on the length of media 22 making it easy to tear the media 22 into sections.

When placed with the invention 10, the papier-mâché media 22 could initially be supported by the papier-mâché media holder 60. In one embodiment, the media holder 60 be located by the exterior 44 of the container 30 proximate to the first edge 46 (e.g., outside the interior 42.) In another embodiment, the media holder 60 could be located in the interior 42 of the container 30 and substantially hold the papier-mâché media 22 that it supports generally up and away from any papier-mâché solution 28 found in the interior 42.

In one embodiment, the media holder 60 could be a removable pin 152 that is moveably connected to one or more support arms 64 attached to the first edge 46. The support arm(s) 64 could support the removable pin 152 so that it is above and parallel to the first edge 46. The removable pin 152 could accept a papier-mâché media roll 26.

In another embodiment of the invention, the media holder 60 could be a half tube 66 that has a generally rightside up orientation and is generally attached to the first edge 46. The half tube 66 could be further disposed so that its longitudinal axis 68 is generally parallel to the first edge 46. The papier-mâché media roll 26 could initially loaded onto the apparatus 20 by being placed onto the half tube 66. The depth of the half tube 66 could be sufficiently deep so that when media 22 is stripped off the roll 26, the roll 26 can generally rotate without being dislodged from the half tube 66.

The one or more bottom rollers 70 could be one or more rods 72 reversibly attached at opposing points on opposing side walls 38 using attachment means 74 known in the art. In one embodiment, the rods 72 are fixed and do not move and merely act as guides for the media 22. In another embodiment, the attachment means 74 could allow the rod(s) 72 to rotate during operations to facilitate the movement of a strip or a portion of papier-mâché media 22 though the apparatus 20. In yet another embodiment, the bottom roller 70 could be comprised not only of the rod 72 but also a hollow tube 76 that rotates freely about the rod 72. The media 22 could lo then be fed about at least a portion of the hollow tube 76.

At least one bottom roller 70 could be so located that it is generally proximate to the bottom 40 and the first end wall 34. During operations, a strip of media 22 pulled off from the media 22 that is supported by the media holder 60 can be directed around the bottom roller 70. The bottom roller 70, when submerged within the papier-mâché solution 28 held in the interior 42, could assist the wetting of the strip of media 22 directed around it.

At least one embodiment could further deploy a second bottom roller 78 (e.g., located proximate to the second end wall 36 and the bottom 40). In this embodiment, the strip of media 22 coming from the first bottom roller 70 could then be then fed around the second bottom roller 78. In doing so, the movement of the strip of media 22 from one bottom roller 70 to another 20 along the bottom 30 of the container 30 to the second bottom roller 78 could keep the papier-mâché strip submerged in papier-mâché solution 28 present in the interior 42 for a generally thorough wetting. Media 22 coming off from the roller(s) 70, 78 is then generally removed from the papier-mâché solution 28.

The wiper device 80 could be located in the interior 42 at a position generally proximate to the second edge 48 and above papier-mâché solution 28 that is to be generally found in the interior 42. The wiper device 80 could be so constructed to generally make simultaneous contact with each side of the wetted strip of media 22 after it is removed from the papier-mâché solution 28 to substantially remove excess papier-mâché solution 28 from the wetted media 22.

In one embodiment, the wiper device 80 could be two flexible blades (not shown) held in close opposing planar orientation wherein a respective edge of the flexible blades simultaneously scrapes an opposing sides of the wetted media 22 passing between the blades. Another version of the wiper device 80 could employ a pair of brushes (not shown) held in close opposing planar orientation between which the strip of wetted papier-mâché media 22 is fed.

Yet another version of the wiper device embodiment could employ a pair of rotatable hollow core rollers 84 generally held together in side-by side parallel configuration. The hollow core rollers 84 could be made of flexible material (e.g., foam) having a hollow core 86 terminating in double open ends. Each hollow core roller 84 could be movably mounted around a rod 72 running through the hollow core 86. The opposing ends of the rods 72 could be respectively affixed to opposing side walls 38. The strip of wetted media 22 could then be passed in between the rotatable hollow core rollers 84 to remove excess papier-mâché solution 28.

The cutting device 90, generally located proximate to the second edge 48 on the exterior 44, could encompass a wide variety of cutting means. The cutting device 90 in various embodiments of the invention could include, but not necessarily be limited to: the second edge 48 formed with a sharp surface 92, the second edge formed with a serrated surface 94, a cutting apparatus 96 (e.g., a scissors mounted to the open top container 30) mounted to the second edge 48, or other suitable cutting means generally known in the art.

The type of cutting device 90 selected for the papier-mâché apparatus 20 could also depend on the type of papier-mâché media 22 that is used by the apparatus 20. For example, wetted perforated papier-mâché media 22 could be separated along its perforation 27 by breaking the perforation 27 along a sharp surface 92 or the like. The wetted media 22 not having the perforation 27 may require a different cutting means such the serrated surface 94 or the like.

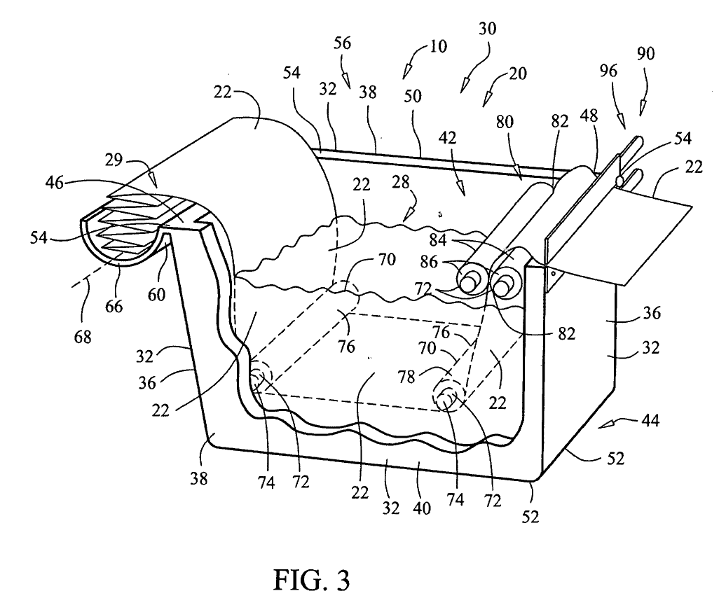

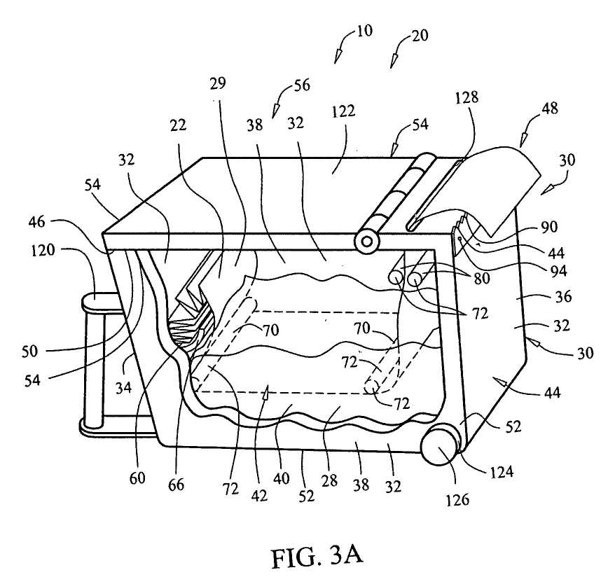

As generally shown in FIG. 3A, at least one embodiment of the invention 10 could be further comprise a hinged cover 122 located over and generally reversibly enclosing the open top 56 of the container 30. The container 30 could further feature a drain 124 and corresponding drain plug 126 for the removal of papier-mâché solution from the interior 42. The papier-mâché media holder 60 (and the media 22 that it supports) for this embodiment could be placed within the interior 42 as described above. The hinged cover 122 could be so constructed as to generally access to the interior 42 for the placement of papier-mâché media 22 into the media holder 60; the subsequent feeding of a strip of media 22 through the bottom roller(s) 70 and the wiper device 80; the feeding of strip of media 22 through a slot 128; and the adding of papier-mâché solution 28 into the interior 42.

The container 30, proximate to the hinged cover 122, could further feature the slot 128 that substantially allows for a continous connection between the exterior 44 and the interior 42. The strip of wetted media 22, as moved from the wiper device 80, could be fed through the slot 128 to move the strip of media 22 from the interior 42 to the exterior 44 and generally proximate to the cutting device 22 located on the exterior 44 by the second edge 48.

This embodiment could further feature a handle 120 located on the exterior 44 (e.g., substantially attached to the first end wall 34) to generally allow the operator to hold the apparatus 20 in one hand and use the other hand to remove wetted papier-mâché media 22 from the interior 42 (e.g., thumbing wetted media 22 from the slot 128) or cutting lengths of wetted media 22 with the cutting device 90.

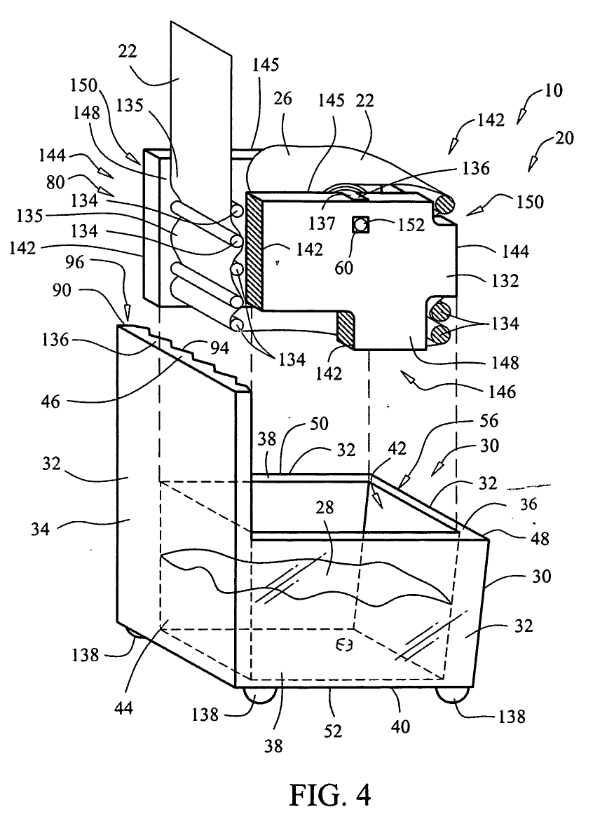

As substantially shown in FIG. 4, another embodiment of the papier-mâché apparatus 20 could be comprised of an open top container 30 and a papier-mâché media dispenser 130, a part of the dispenser 130 may enter and be supported by the interior 42 of the container 30. The container 30 may have a first end wall 34 whose height is generally greater than that of the remaining three other walls 32. This adaptation could allow the first end wall 34 to possibly present a cutting device 90 at its top edge 54. In at least one embodiment, the cutting device 90 could be a top edge 54 of the first end wall 34 formed to have a serrated surface 94.

The open top container 30 could be further comprised of four cushion pads 138, with a cushion pad 138 respectively located in each of the four corners of the underside of the bottom 40. The cushion pads 138 could be used to substantially prevent scuffing damage to any furniture to which the invention 10 comes into contact. Further, the cushion pads 138, by raising the bottom 40 up and away from any such furniture, may possibly reduce any possible water damage or the like by any papier-mâché solution 28 that may have left the interior 42 and accumulated on the underside of the bottom 40 of the open top container 30 during operations.

The papier-mâché media dispenser 130 could be comprised of a pair of dispenser walls 132, a plurality of pins 134, and a media holder 60. The pair of dispenser walls 132 generally held apart in opposing or parallel configuration by a plurality of pins 134 having generally perpendicular orientation to the dispenser walls 132. The dispenser walls 132 could have a first end 142, a second end 144, a top 145, a bottom 146, an interior side 147, and an exterior side 148. The pins 134 could be attached to and orient the dispenser walls 132 so that the walls interior sides 147 could be facing each other. The dispenser walls 132 could also have a height that is less than that of the first wall 34 of the open top container 30.

In at least in one embodiment, the plurality of pins 134 could be metallic, plastic, or of other suitable material and generally be held in place into appropriately placed corresponding pin apertures 135 in the walls 132 by press fit. In another possible embodiment, the pins 134 could be made integral with one dispenser wall 132 (e.g., the same molding) and could then fit into respective pin apertures 135 in the other dispenser wall 132.

The plurality of pins 134 could be further divided into of two sets of pins 150, each of the sets 150 generally being located between the interior sides 147 proximate to their respective ends (e.g., the first ends 142 and the second ends 144 of the dispenser walls 132.) The set of pins 150 proximate to the first ends 142 could have five pins 134 while the second set of pins 150 proximate to the second ends 144 could have three pins 134.

The set of pins 150 proximate to the second ends 142 could be arranged in generally planar vertical orientation with one pin 134 located proximate to the tops 145 and another pin 134 located proximate to the bottoms 146 of the dispenser walls 132. The third pin 134 could be so located as to be slightly spaced apart from and directly above the pin 134 proximate to the bottoms 146.

The set of pins 150 proximate to the first ends 142 could have its five pins 134 generally spaced apart in a vertical planar orientation so that the first pin 134 could be proximate to the tops 145 and the fifth pin 134 could be proximate the bottoms 146 and the other three pins 134 accordingly located in between these two pins 134.

The pins 134 orientation of the dispenser walls 132 could allow a papier-mâché media roll 26 to be loaded between the dispenser walls 132, so a strip of papier-mâché media 22 may be taken off a papier-mâché media roll 26, and pulled over to the set of pins 150 proximate to the second ends 144. The strip of media 22 could be brought up and over the first pin 134 of this set (e.g., located proximate to the tops 145) and then brought down and interwoven through the remaining pins 134 of the set 150 to substantially bring the strip of media 22 to the bottoms 146 near the second ends 142. The strip of media 22 is then brought from this set 150 to the bottoms of the first end 142 where the strip is interwoven up through the set of five pins 150 proximate to the first ends 142.

The third (e.g., bottom) pin 134 of the pin set 150 proximate to the second ends 144 and the fifth (e.g., bottom) pin of the pin set 150 proximate to the first ends 142 could hold and orient the papier-mâché media 22 between the two pins 137 so as to substantially expose the media 22 to the bottom 40 of the open top container 30 and to papier-mâché solution 28 present in the interior 42.

The set of pins 150 proximate to the second ends 144 could be so arranged as to generally impart a frictional force that could generally impede or slow the otherwise free movement of the media 22 from the roll 26 through the dispenser 130 (e.g., unwinding there from and entering the bottom 40 to prematurely contact papier-mâché solution 28 present.) The set of pins 150 proximate to the first ends 142, by having the wetted papier-mâché media 22 interwoven through them, may similarly impart a frictional drag to prevent the wetted media 22 from being too easily or quickly removed from any present papier-mâché solution 28. As such, both sets of pins 150 could also help maintain a level of tension upon the strip of media 22 to keep it generally taut so generally help the media 22 from becoming possibly fouled up in the dispenser 130.

The set of pins 150 proximate to the second ends 144 could further generally provide a wiping action (e.g., be the wiper device 80) to possibly remove excess papier-mâché solution 28 from the wetted papier-mâché media 22. Further, the orientation of this set of pins 150 proximate to the first ends 142 could place the wetted media 22 in a vertical orientation that is also parallel to the first end wall 34 of the open container 30. This media 22 orientation could facilitate the cutting of the wetted media 22 into sections as the wetted media 22 is brought to the first edge 46 (e.g., in an up-and-over fashion) and into contact with the cutting device 90 (e.g., serrated edge 94, or like).

The media holder 60 in one version could be a removable pin 152 that could be used to position at least a portion of a papier-mâché roll 26 between the dispenser walls 132 and a set of open channels 136 on the dispenser walls 132. The removable pin 152 could be substantially held in a generally perpendicular orientation to and between the dispenser walls 132 by the set of opposing open channels 136. Each open channel 136 could be vertically located upon the upper half of a respective interior side 147 of the dispenser wall 132. Each open channel 136 could have at least one end terminate in an open end 139 that is generally located at the middle of the top 145 of the dispenser walls 132 that generally allows a removable pin 152 to be moved in and out of the open channels 136. In this manner, a roll 26 of papier-mâché media 22 (e.g., having its hollow core mounted upon on the removable pin 152) could be moveably located between the two dispenser walls 132. The construction of the open channels 136 could be such that the media roll 26 could generally be held away from direct contact with any papier-mâché solution 28 that may be placed in the interior 42.

In another version of this embodiment, the media holder 60 could be a shelf (not shown) located between the dispenser walls 132 that could generally prevent the supported media 22 from generally contacting papier-mâché solution 28 that may be held in the interior 42.

In this manner, the papier-mâché media dispenser 130 (e.g., when removed from the open container 30) could be loaded with papier-mâché media 22, with a strip of media 22 being pulled off (e.g., from the media roll 26) and appropriately threaded through at least several of the plurality of pins 134. Enough papier-mâché solution 28 could be loaded in the interior 42 of the open container 30 to wet the papier-mâché media 22 substantially located at the bottoms 146 of the papier-mâché media dispenser 130 but generally not wet media 22 being held by the removable pin 152 and the like. At least a portion of the papier-mâché media dispenser 130 could be placed into the interior 42 so that the media 22 proximate at the bottoms 146 is close to the bottom 40 of the container 30 and is otherwise could be in contact (e.g., submerged) within the papier-mâché solution 28 held in the open top container 30. The pulling on the papier-mâché media 28 located at the first end 142 of the dispenser 130 should move new papier-mâché media 22 from the papier-mâché media holder 140 into and through the papier-mâché solution 28 to neatly create a length of papier-mâché.

Methodology

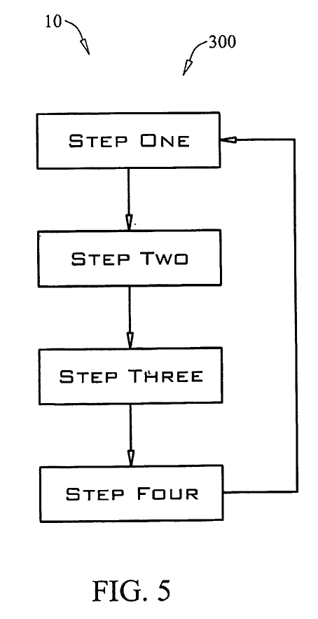

As substantially shown in FIG. 5, one possible process 300 of operating the invention 10 could start with step one, loading the invention 10. For the embodiment of the invention 10 not having a papier-mâché media dispenser 130, this step could commence with the media stock 22 being placed in the paper stock or media holder 60. In the version of this embodiment, where the container 30 has a hinged cover 128, the cover 128 could be opened first to allow access to the interior 42 and the media holder 60. After the media 22 is placed in the holder 60, a strip of media 22 could be stripped off and fed around and over the first edge 46. The strip of media 22 could then be fed through to and around the bottom roller(s) 70 and the like located proximate to the bottom 40 of the container 30. The media 22 could then be taken from the bottom roller(s) 22 and the like and fed through the wiper device 80. In the embodiment of the invention 10 having a hinged cover 122, the media could be further threaded through the slot 128 to bring the media 22 outside of the container 30. The media 22 could then be taken to the second edge 48 proximate to the cutting device 90.

In the embodiment of the invention 10 having a papier-mâché media dispenser 130, step one could commence with placement of a papier-mâché or paper roll 24 being placed over the removable pin 152. The ends of the removable pin 152 then engage the open tops 137 to load a removable pin 152 into the open channels 136 and thus load the papier-mâché roll 26 into the papier-mâché media dispenser 130.

A strip of papier-mâché media 22 is pulled off of the roll 26 and taken over to the top pin 137 of the set of pins 150 proximate to the second ends 144 where the media 22 is interwoven downward through that set of pins 137. The strip of media 22 is then taken from that set f pins 150 along the respective bottoms 146 to be brought around the bottom pin of the set of pins 150 proximate to the first ends 142. The strip of media 22 is then interwoven up through the remaining pins 137 of that set 150.

Once step one is substantially completed, the process 300 could proceed to step two, loading the solution.

Step two, loading the solution, could start with the making an appropriate amount of papier-mâché solution 28 from a desired formula. A suitable amount of papier-mâché solution 28 could then be added to the interior 42 of the open top container 30. In the embodiment of the apparatus without the papier-mâché media dispenser 130, the amount of papier-mâché solution 28 could be added until the bottom roller(s) 70, 78 or the like that are proximate to the bottom 40 of the container 30 are generally submerged in the papier-mâché solution. After loading the papier-mâché solution 28 in the papier-mâché media disperser embodiment, the papier-mâché media dispenser 130 could be loaded into the open top container 30. After substantially completing step two, the process 100 could proceed to step three, pulling the media through the apparatus.

Step three, pulling the media through the apparatus, could start with the operator grasping that portion of the media 22 adjacent to the second edge 48 (or the tops 145 of the first ends 142 for the dispenser embodiment) and pulling the media 22 away from the second edge 48 (or the first ends 142). In the embodiment deploying a hinged cover 122, the wetted media 22 could come out of the interior 42 through the slot 128, whereby the operator could advance the media 22 by moving the operator's thumb over wetted media 22 coming out of the slot 128 to pull more media out of the slot 128.

In the embodiment without the papier-mâché media dispenser 130, as the movement of the wetted media 22 to the exterior 44 of the container 30 occurs, more dry media 22 is generally pulled and stripped from the media holder 60 and enters into the solution 28. As the media 22 enters the papier-mâché solution 28, it is directed towards the bottom 40 of the container 30 to the first bottom roller 70. The media 22 continues to move to the second bottom roller 78 (if so employed) in the solution 28, to generally ensure an adequate submersion and wetting of the media 22. The wetted media 22 is then moved out from the bottom roller(s) 70, 78 and away from the papier-mâché solution 28. The media 22 is then brought through the wiper device 80 to wipe both sides of the wetted media 22 to generally remove excess papier-mâché solution 20 from the wetted media 22.

The wetted media 22 then leaves the wiper device 80 (e.g., though the slot 128 if so employed) wherein the operator can bring the desired length of wetted media 22 (e.g., papier-mâché) proximate (by thumbing the wetted media 22 out of the slot 128) to the second edge 48 and the cutting device 90. The operator may then suitably engage the cutting device 90 to create the desired length of papier-mâché.

In the embodiment featuring the papier-mâché media dispenser 130, the media 22 may be stripped off the papier-mâché media roll 26 and over to the set of pins 150 proximate to the second ends 144 and interwoven downward through the pins 137 toward the bottoms 146 of the second ends 144. The strip of media 22 moves from that set of pins 150 along the bottoms 146 (and is brought into contact with the papier-mâché solution 28 during this portion of the process). The wetted strip of media 22 then enters the set of pins 150 located proximate to the first end 142 by the bottom pin to interweave upward through the remaining pins 137 to the tops 145 of the first end 142.

The wetted strip of media 22 is pulled along side the first end wall 34 of the container 30 until the desired amount of wetted strip of media 22 (e.g. papier-mâché) is brought past the first edge 46. The operator than can bring the wetted strip of media 22 up and over the first edge 46 to engage the cutting device 90 to create the desired length of papier-mâché.

At the substantial completion of step three, the process 300 could proceed to step four, the clean up.

At step four, the clean up, the embodiment without the dispenser 130 could proceed by having papier-mâché media 22 removed from the media holder 60 and discarding any unused wetted media 22. The remaining dry media 22 could be suitably stored. The papier-mâché solution 28 may then be removed from the open top container 30 (e.g., poured out from the open top 56.)

In the embodiment of the apparatus 20 having a drain 124, the drain plug or stopper 126 could be removed from the drain 124, generally allowing the papier-mâché solution to be drained out of the container 30. In both instances, the papier-mâché media solution 28 that is removed from the container 30 may be disposed of or otherwise suitably handled.

The emptied papier-mâché apparatus 20 can then be washed out with water and the like to remove any remaining traces of papier-mâché solution 28. The papier-mâché apparatus 20 can then be dried off and suitably stored.

In the embodiment having the papier-mâché media dispenser 130, the dispenser 130 is removed from the container 30. The papier-mâché solution 28 is removed from the container 30 to be properly discarded or otherwise suitably handled.

The remaining dry media 22 is removed from the media holder 60 and any unused wetted media 22 is discarded. The remaining dry media 22 is suitably stored. The container 30 and the dispenser 130 are then washed in water to clean off any remaining solution 28, dried, and stored

At the substantial completion of the step four, the process 300 could proceed back to step one when the creation of more papier-mâché is desired.

### CONCLUSION

As seen from the above-description and below claims, the invention is generally capable of allowing papier-mâché practitioners of all ages to make papier-mâché strips with greater ease and lesser mess by utilizing a papier-mâché forming apparatus that is generally self-contained and can make papier-mâché upon demand using a continous supply of papier-mâché media.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. An apparatus for making papier-mâché comprising:
(A) an open top container, the open top container forming a hollow interior capable of holding an amount of papier-mâché solution;
(B) a papier-mâché media dispenser, a portion of the papier-mâché media dispenser can reversibly sit within the hollow interior of the open top container, the dispenser further comprising a pair of dispenser walls spaced apart in parallel opposing configuration by a plurality of pins that are located between the walls;
(C) a papier-mâché media holder, the papier-mâché media holder reversibly located between the dispenser walls;
wherein the plurality of pins are so spaced as to allow a strip of the papier-mâché media being held by the papier-mâché media holder to be freely interwoven through several of the pins so as to movably present a portion of the strip of media to a papier-mâché solution present in the interior.

2. A papier-mâché apparatus of claim 1 wherein the plurality of pins may comprise two sets of pins, one set of pins located proximate to the first ends of the dispenser walls while another set of pins located proximate to the second ends of dispenser walls.

3. A papier-mâché apparatus of claim 2 wherein each set of pins is placed in a planar vertical orientation.

4. A papier-mâché apparatus of claim 3 wherein two or more pins in the one set of pins located proximate to the first ends act as a wiper means for wetted papier-mâché media interwoven through these pins to remove excess papier-mâché solution from the wetted papier-mâché media.

5. A papier-mâché apparatus of claim 3 wherein the pins in the one set of pins located proximate to first ends act to impart a frictional force that impinges on the movement of the papier-mâché media interweaving upward through these pins to prevent the media from leaving the papier-mâché solution prematurely.

6. A papier-mâché apparatus of claim 3 wherein the pins in the one set of pins located proximate to second ends of the dispenser walls act to impart a frictional force to impinge on the movement of the papier-mâché media interweaving downward through these pins to prevent the media from entering the papier-mâché solution prematurely.

7. A papier-mâché apparatus of claim 3 wherein one set of pins located proximate to the first ends can present a wetted papier-mâché media interwoven upward through this set of pins parallel to a wall of the container bearing a cutting device.

8. A papier-mâché apparatus of claim 3 wherein as the papier-mâché media is placed through the two sets of pins, the movement of media between the two sets of pins places the media in contact with the papier-mâché solution present in the interior.

9. A papier-mâché apparatus of claim 1 wherein the plurality of pins are perpendicularly oriented to the walls.

10. A papier-mâché apparatus of claim 9 wherein the plurality of pins are integral with one dispenser wall and can fit into corresponding pin apertures on the other dispenser wall.

11. A papier-mâché apparatus of claim 1 wherein the papier-mâché media holder may be comprised of a set of open channels on the interior sides of the dispenser walls and a removable pin capable of holding a roll of papier-mâché media, the open channels reversibly receiving a portion of the removable pin.

12. A papier-mâché apparatus of claim 1 wherein the open top container further comprises a cutting device, the cutting device being located on a wall of the open top container, the wall having greater height than the heights of the other walls of the container and the dispenser.

13. A papier-mâché apparatus of claim 1 wherein the papier-mâché media has a plurality of laterally disposed perforations to aid in cutting the media into sections.

14. A papier-mâché apparatus comprising:
(A) an open top container having a bottom and a plurality of walls forming an exterior, the exterior denoting a hollow interior that can hold an amount of papier-mâché solution; at least one wall being a first wall and the wall opposing the first wall being a second wall,
(B) a papier-mâché media holder for supporting a papier-mâché media, the holder being located on the first wall's exterior;
(C) a cutting device being located on the second wall's exterior;
(D) at least one bottom roller being located in the interior proximate the bottom and the first wall;
(E) one wiper device being located in the interior proximate to the second wall;
wherein a strip of papier-mâché media is taken from papier-mâché media supported by the papier-mâché media holder and is threaded under at least one bottom roller to place the media in an amount of papier-mâché solution placed in the interior, the media then further being taken from the bottom roller to be threaded through a wiper device, the media then further being taken from the wiper device to be placed proximate the exterior by the cutting device.

15. An apparatus of claim 14 further comprises a second bottom roller proximate to the bottom and second wall, the strip of media coming from the first bottom roller is fed under the second bottom roller before being directed to the wiper device.

16. An apparatus of claim 14 wherein the papier-mâché media has a plurality of laterally disposed perforations to aid in cutting the media into sections.

17. A papier-mâché making apparatus comprising:
(A) an open top container with an exterior defining a hollow interior, the hollow interior containing a papier-mâché media holder, at least one bottom roller, and a wiper device, the interior further capable of receiving and holding an amount of papier-mâché solution;
(B) a hinged cover to allow access to the interior;
(C) a slot continuously connecting the interior to the exterior;
wherein a portion of papier-mâché media loaded onto the papier-mâché media holder is stripped off and movably fed around at least a portion of at least one bottom roller, the bottom roller bringing the media into contact with papier-mâché solution placed in the interior, the media being further brought from the bottom roller to be in contact with the wiper device, and the media being further brought from the wiper device to be fed into and then out of the slot, thus allowing the media to be proximate with the exterior of the container.

18. An apparatus of claim 17 wherein the media is further taken from the slot and moved proximate to a cutting device mounted on the exterior.

19. An apparatus of claim 17 wherein the wiper device is a pair of rollers in close proximity to one another and between which the papier-mâché media may be fed.

20. An apparatus of claim 17 further comprising a handle mounted on the exterior.
